(19) United States
(12) Patent Application Publication
(10) Pub. No.: US 2016/0183498 A1
(43) Pub. Date: Jun. 30, 2016

(54) Avian Transport Box Device

(71) Applicant: Tim Omland, Ipswich, SD (US)

(72) Inventor: Tim Omland, Ipswich, SD (US)

(21) Appl. No.: 14/587,514

(22) Filed: Dec. 31, 2014

(51) Int. Cl. A01K 31/07; A01K 31/10

(52) U.S. Cl. CPC A01K 31/07; A01K 31/10

(57) ABSTRACT

An avian transport box device transports birds economically and allows a person to extend a hand through a perimeter wall of the device to extract birds while multiple devices are stacked. The device includes a perimeter wall coupled to and extending from a perimeter edge of a bottom wall defining an enclosure. A top wall coupled to the perimeter wall is positionable to cover the enclosure. Each of a plurality of apertures extends through the perimeter wall. An opening extends through the perimeter wall. A door pivotally coupled to the perimeter wall is positionable in the opening for preventing a bird from exiting the enclosure through the opening until the door is opened. A cover panel coupled to the top wall is positionable over the opening in the perimeter wall and the door while the top wall is covering the enclosure.

### BACKGROUND OF THE DISCLOSURE

1. Field of the Disclosure

The disclosure relates to transport box devices and more particularly pertains to a new transport box device for transporting birds economically and allowing a person to extend a hand into a perimeter wall of the box to extract birds while multiple boxes remain stacked.

2. Summary of the Disclosure

An embodiment of the disclosure meets the needs presented above by generally comprising a perimeter wall coupled to and extending from a perimeter edge of a bottom wall defining an enclosure. A top wall coupled to the perimeter wall is positionable to cover the enclosure. Each of a plurality of apertures extends through the perimeter wall. An opening extends through the perimeter wall. A door pivotally coupled to the perimeter wall is positionable in the opening for preventing a bird from exiting the enclosure through the opening until the door is opened. A cover panel coupled to the top wall is positionable over the opening in the perimeter wall and the door while the top wall is covering the enclosure.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a top front side perspective view of a avian transport box device according to an embodiment of the disclosure.

FIG. 2 is a top front side perspective view of an embodiment of the disclosure in a partially closed position.

FIG. 3 is a top front side perspective view of an embodiment of the disclosure in a fully closed position.

FIG. 4 is a top view of an embodiment of the disclosure in an unassembled position.

### DESCRIPTION OF THE PREFERRED EMBODIMENT

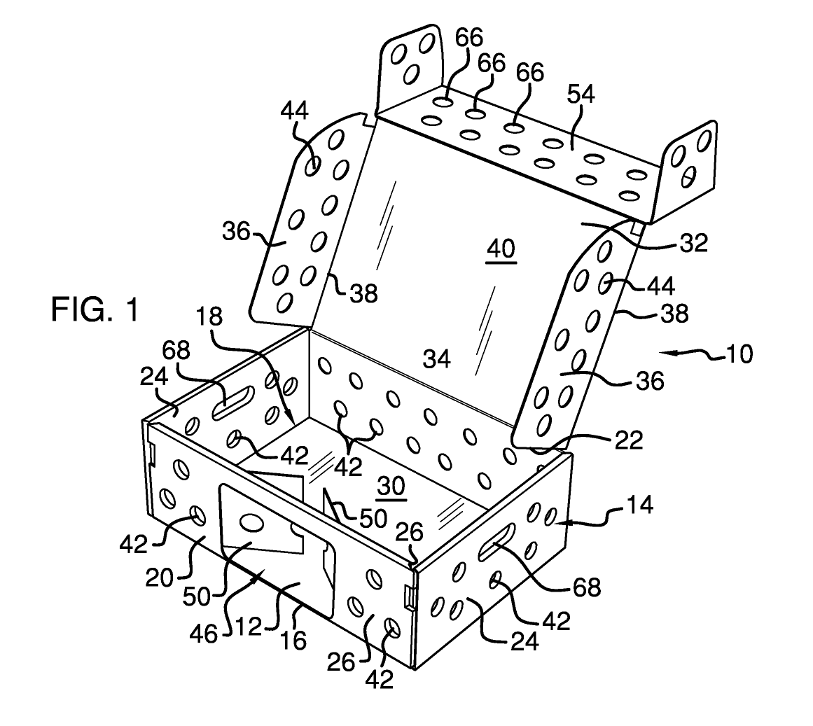

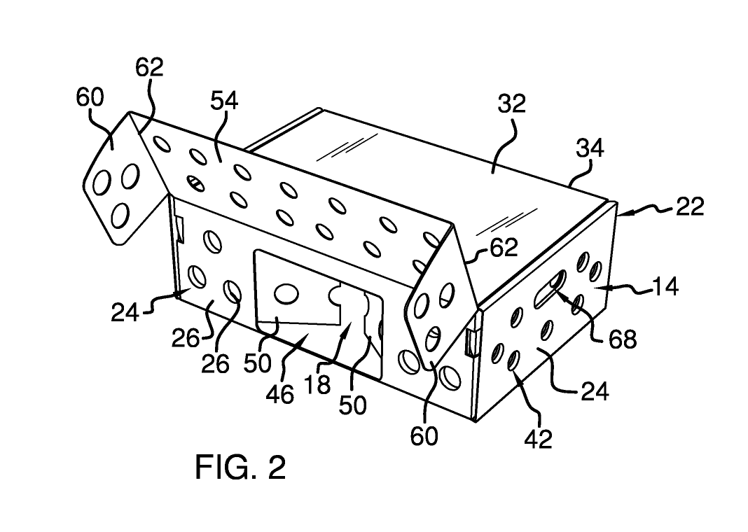

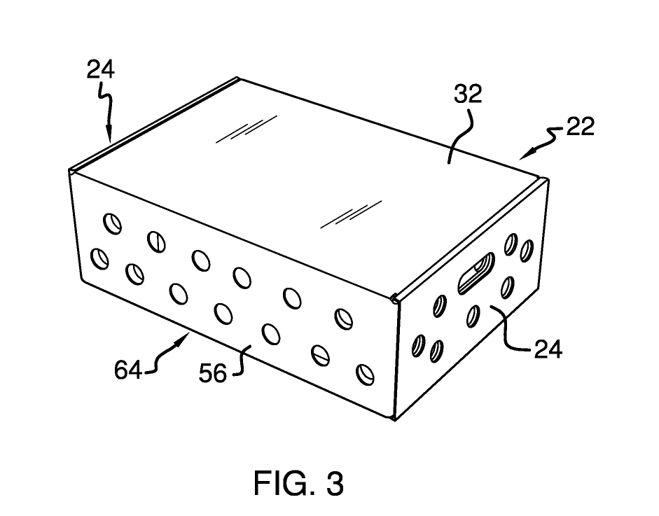

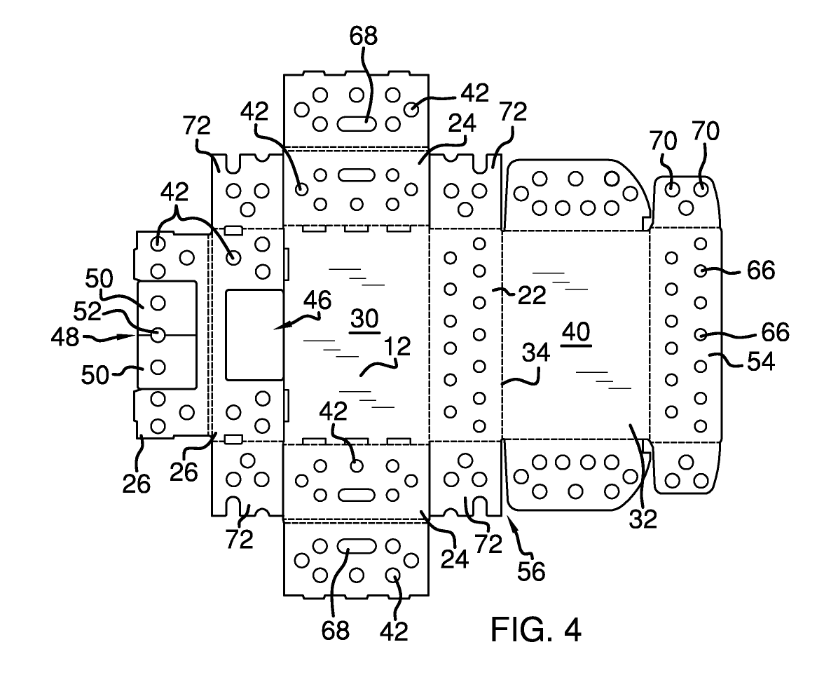

With reference now to the drawings, and in particular to FIGS. 1 through 4 thereof, a new transport device embodying the principles and concepts of an embodiment of the disclosure and generally designated by the reference numeral 10 will be described.

As best illustrated in FIGS. 1 through 4, the avian transport box device 10 generally comprises a bottom wall 12 and a perimeter wall 14 coupled to and extending from a perimeter edge 16 of the bottom wall 12 defining an enclosure 18. The perimeter wall 14 has a front section 20, a back section 22, and a pair of side sections 24. The front section 20 is formed by a pair of folded and overlapping front portions 26. Similarly, each side section 24 is formed by a respective pair of folded and overlapping side portions 28. The bottom wall 12 forms a continuous unperforated floor surface 30 of the enclosure 18. A top wall 32 is coupled to the perimeter wall 14 along a back edge 34. The top wall 32 is pivotable relative to the back section 22 such that the top wall 32 is positionable to cover the enclosure 18. Side flaps 36 may extend from respective lateral edges 38 of the top wall 32. The top wall 32 forms a continuous unperforated ceiling surface 40 for the enclosure 18.

Each of a plurality of apertures 42 extends through the perimeter wall 14. Additionally, each side flap 36 has associated holes 44 which align with associated apertures 42 when the side flaps 36 are positioned adjacent to the perimeter wall 14 while the top wall 32 covers the enclosure 18.

An opening 46 extends through the perimeter wall 14. The opening 46 extends through the front section 20 of the perimeter wall 14. The opening 46 is sufficiently large to allow a person to extend a hand therethrough into the enclosure 18. A door 48 is pivotally coupled to the perimeter wall 14. The door 48 is positionable in the opening 46 wherein the door 48 is configured for preventing a bird from exiting the enclosure 18 through the opening 46 until the door 48 is opened. The door 48 may comprise a pair of door sections 50 formed by a H-shaped cut line through the front section 20 of the perimeter wall 14. Apertures 42 may extend through the door 48 as the door in a closed position forms a part of the perimeter wall 14. A central door aperture 52 may be formed by semi-circular cutouts in the door sections 50 facilitating engagement of and closing of the door sections 50.

A cover panel 54 is coupled to the top wall 32. The cover panel 54 is positionable over the opening 46 in the perimeter wall 14 and the door 48 while the top wall 32 is covering the enclosure 18. Each of the bottom wall 12, the perimeter wall 14, the top wall 32, the door 48, and the cover panel 54 is integrally formed from a single panel of material 56. The single panel of material 56 may be corrugated cardboard or the like of sufficient strength to allow for stacking of several individual boxes without crushing of the respective enclosures 18. Corner sections 72 may be provided to further strengthen the device 10 when the single panel of material 56 is folded into the closed position 64.

Each of a pair of closing tabs 60 is coupled to an associated end 62 of the cover panel 54. Each closing tab 60 is insertable between the side portions 28 of an associated one of the side sections 24 wherein the cover panel 54 is held in a closed position 64 over the front section 20 of the perimeter wall 14. The cover panel 54 is structured to include associated holes 66 aligning with the apertures 42 through the front section 20 of the perimeter wall 14. Each of a pair of handle slots 68 extends through an associated one of the side sections 24 of the perimeter wall 14. Each of the closing tabs 60 also includes associated holes 70 to align with the apertures 42 in the side sections 24 of the perimeter wall 14.

In use, the single panel of material 56 is folded to form the enclosure 18 as described above. Birds or the like may be placed into the enclosure 18 before positioning the top wall 32 or by insertion through the opening 46. The cover panel 54 is positioned over the front section 20 to prevent the birds from passing through the opening 46. The device 10 may be stacked with many other such devices 10 leaving each cover panel 54 and front section 20 exposed allowing a person to selectively move the cover panel 54 providing access to each enclosure 18 through the respective opening 46 by pressing the door 48 inwardly or pulling the door 48 outwardly if so desired.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An avian transport box device comprising:
a bottom wall;
a perimeter wall coupled to and extending from a perimeter edge of said bottom wall defining an enclosure;
a top wall coupled to said perimeter wall, said top wall being positionable to cover said enclosure;
a plurality of apertures extending through said perimeter wall;
an opening extending through said perimeter wall;
a door pivotally coupled to said perimeter wall, said door being positionable in said opening wherein said door is configured for preventing a bird from exiting said enclosure through said opening until said door is opened; and
a cover panel coupled to said top wall, said cover panel being positionable over said opening in said perimeter wall and said door while said top wall is covering said enclosure.

2. The device of claim 1, further comprising said perimeter wall having a front section, a back section, and a pair of side sections.

3. The device of claim 2, further comprising said opening extending through said front section of said perimeter wall.

4. The device of claim 1, further comprising each of said bottom wall, said perimeter wall, said top wall, said door, and said cover panel being integrally formed form a single panel of material.

5. The device of claim 2, further comprising said front section being formed by a pair of folded and overlapping front portions.

6. The device of claim 2, further comprising each said side section being formed by a respective pair of folded and overlapping side portions.

7. The device of claim 6, further comprising a pair of closing tabs, each of said closing tabs being coupled to an associated end of said cover panel, each closing tab being insertable between said side portions of an associated one of said side sections wherein said cover panel is held in a closed position over said front section of said perimeter wall.

8. The device of claim 1, further comprising a pair of handle slots, each said handle slot extending through said perimeter wall.

9. The device of claim 8, further comprising each said handle slot extending through an associated one of said side sections of said perimeter wall.

10. The device of claim 4, further comprising said single panel of material being corrugated cardboard.

11. The device of claim 1, further comprising said bottom wall forming a continuous unperforated floor surface of said enclosure.

12. The device of claim 1, further comprising said top wall forming a continuous unperforated ceiling surface for said enclosure.

13. An avian transport box device comprising:
a bottom wall;
a perimeter wall coupled to and extending from a perimeter edge of said bottom wall defining an enclosure, said perimeter wall having a front section, a back section, and a pair of side sections, said front section being formed by a pair of folded and overlapping front portions, each said side section being formed by a respective pair of folded and overlapping side portions, said bottom wall forming a continuous unperforated floor surface of said enclosure;
a top wall coupled to said perimeter wall, said top wall being positionable to cover said enclosure, said top wall forming a continuous unperforated ceiling surface for said enclosure;
a plurality of apertures extending through said perimeter wall;
an opening extending through said perimeter wall, said opening extending through said front section of said perimeter wall;
a door pivotally coupled to said perimeter wall, said door being positionable in said opening wherein said door is configured for preventing a bird from exiting said enclosure through said opening until said door is opened;
a cover panel coupled to said top wall, said cover panel being positionable over said opening in said perimeter wall and said door while said top wall is covering said enclosure, each of said bottom wall, said perimeter wall, said top wall, said door, and said cover panel being integrally formed from a single panel of material, said single panel of material being corrugated cardboard;
a pair of closing tabs, each of said closing tabs being coupled to an associated end of said cover panel, each closing tab being insertable between said side portions of an associated one of said side sections wherein said cover panel is held in a closed position over said front section of said perimeter wall; and
a pair of handle slots, each said handle slot extending through said perimeter wall, each said handle slot extending through an associated one of said side sections of said perimeter wall.
